(19) United States
(12) Patent Application Publication
(10) Pub. No.: US 2018/0041057 A1
(43) Pub. Date: Feb. 8, 2018

(54) CHARGING DEVICES

(71) Applicant: HEWLETT-PACKARD DEVELOPMENT COMPANY, L.P., HOUSTON, TX (US)

(72) Inventors: KUAN-TING WU, TAIPEI CITY (TW); CHIENLUNG YANG, HOUSTON, TX (US); KEVIN VOSS, HOUSTON, TX (US)

(21) Appl. No.: 15/542,875

(22) PCT Filed: Apr. 27, 2015
(86) PCT No.: PCT/US15/27703

§ 371 Date: Jul. 11, 2017

(51) Int. Cl. H02J 7/00

(52) U.S. Cl. CPC H02J 7/0042; H02J 7/0029

(57) ABSTRACT

Examples of charging devices are described. In an example, a charging device includes a planar supporting structure having a first surface and a second surface, where the first surface includes a plurality of projections extending from the first surface, each of the plurality of projections having a tip end. The first surface is coated with a thermal radiation coating and the tip end of each of the plurality of projections is coated with a thermal insulation coating. Further, a portion of the second surface is coated with a thermal conductive coating.

### BACKGROUND

Communication devices, such as smart phones, tablets, and laptops, are equipped with a rechargeable power source for supporting operation of the communication device. The rechargeable power source is a power source, for example, a battery, which has power stored on it for supporting the operation of the communication devices. Owing to the operation of the communication devices, the power in the rechargeable power source gets depleted. The rechargeable power source may be charged using a charging device, for further operation.

### BRIEF DESCRIPTION OF FIGURES

The detailed description is described with reference to the accompanying figures. The description and figures are merely example of the present subject matter and are not meant to define the scope of the subject matter as claimed.

FIG 1 illustrates a block diagram of charging device, according to an example of the present subject matter.

FIG. 2 illustrates a block diagram of a charging device, according to an example of the present subject matter.

FIG. 3 illustrates a block diagram of a charging device, according to an example of the present subject matter.

FIG. 4 illustrates a block diagram of a charging device, according to an example of the present subject matter.

### DETAILED DESCRIPTION

Charging devices are used for charging communication devices, such as laptops, tablets, mobile phones, personal digital assistants, and smart phones. During operation of a charging device, components of the charging device may heat up, for example, due to prolonged use. Overheating of a component may affect the functioning of the component or, in some cases, may result in damaging the component. Furthermore, overheating of the components may manifest in the form of the outer surface of the charging device heating up. In such a case, users of the charging device may experience discomfort due to the heated surface of the charging device or sustain minor heat related injuries, if they come in contact with the heated surface.

In order to avoid over-heating and to maintain the temperature of the components within their suitable operating temperature, the charging devices are provided with heat sinks. A heat sink is a device which may be mounted onto, and in contact with, a component for dissipating heat generated by the component. The heat sink extracts the heat generated by the component and dissipates it to the external environment thereby maintaining the temperature of the component. The heat sink comprises a base and a plurality of pins or fins extending from the base. Generally, the heat sink is so positioned such that the base of the heat sink abuts the component while a tip end of the pins is facing a surface of the charging device. Generally, a material, such as a metal or an alloy, exhibiting high thermal conductance may be used for fabricating the heat sink. The high thermal conductance of the material facilitates in dissipation of the heat.

Though the high thermal conductance of the material facilitates in dissipation of heat, it also causes the heat sink to heat up. Since the components and the heat sink may be generally enclosed within the charging device, heating up of the heat sink may, in turn, result in heating of the body of the charging device. For instance, within the charging device the heat sink may be housed within a casing. In such a case, certain inner regions of the casing may be proximal to the pins of the heat sink. As a result, in operation the tip end of the pins may have the highest temperatures, which may cause an inner surface and the inner environments of the charging device, in vicinity of the tip ends, to heat up. The heat thus generated may be subsequently transferred from the inner regions to the outer surfaces of the charging device. As mentioned above, heating up of the surface may cause discomfort to a user of the charging device or may put the user at a risk of sustaining heat related injuries. In another example, if the heat sink is fabricated from a material having low thermal conductance, the heat sink may not effectively dissipate the generated heat. As a result, the components of the charging device may overheat and may, in some cases, get damaged over prolonged usages.

The present subject matter relates to a charging device, and other such charging apparatus, incorporating a planar supporting structure which is utilized for effective dissipation of heat generated from various components of the charging device.

According to an example, the planar supporting structure includes a first surface and a second surface. The first surface may include a plurality of projections. The projections may extend from the first surface and terminate at an end, referred to as a tip end. The projections may have different shapes and profiles. In an example, the planar supporting structure may be a heat sink wherein the projections may be pins, which extend outwardly from the base of the heat sink. Each of such pins may include a tip end.

In an example, the first surface may have a thermal radiation coating applied over it. The thermal radiation coating affects radiation of heat from the first surface. In an implementation, the entire area of the first surface may be coated with the thermal radiation coating. In such a case, the thermal radiation coating thus applied, may also coat the surfaces of the tip end of each of the projections. In another implementation, a portion or specific portions of the first surface may be coated with the thermal radiation coating. The thermal radiation coating may enhance the rate at which heat is dissipated by the first surface. The thermal radiation coating may be based on various allotropic forms of carbon, such as graphene, carbon nanotubes, diamond like carbon, and graphite. Additionally, a portion of the second surface of the planar supporting structure is coated with a thermal conductive coating for affecting conductance and extraction of heat from the components. When mounted with components of the charging device, the coating of the thermally conductive material is interspersed between the second surface and the components.

In continuation to the above, the tip ends of the projections may also have a thermal insulation coating applied over a portion of the thermal radiation coating for minimizing heat dissipated through the tip ends. As a result, even though the tip end may get heated the most, the environment surrounding the tip end or any inner surfaces of the charging device, may not get heated up as much.

In another example, prior to applying the thermal radiation material, the tip end of the projections is initially coated with the thermal insulation coating. Once the thermal insulation coating is applied to the tip end of the projections, the remaining surface area of the first surface is applied with the thermal radiation coating.

As explained in the present description, effective heat dissipation in conjunction with suitable insulation against the heat dissipated is achieved in charging device incorporating the planar supporting structure. Thus, overheating and related damages, of both, the integral components and the surface of the charging device may be avoided. Additionally, discomfort to the user or likelihood of undesirable heat related injuries due to physical contact with the charging device is also reduced.

The above aspects are further described in conjunction with figures and associated description below. It should be noted that the description and figures merely illustrate the principles of the present subject matter. Therefore, various arrangements that embody the principles of the present subject matter, although not explicitly described or shown herein, can be devised from the description and are included within its scope.

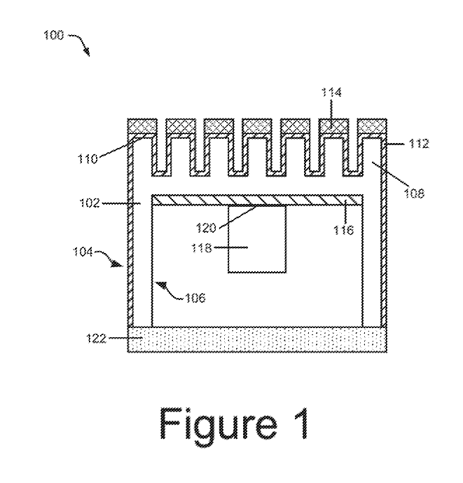

FIG. 1 illustrates a block diagram of a charging device 100, according to an example of the present subject matter. In an example, the charging device 100 may be a wireless charger for charging communication devices, such as smart phones, tablets, and personal digital assistants, supporting wireless charging technology. Generally, charging devices, such as the charging device 100, charge communication devices when such communication devices are placed in immediate proximity of the charging device 100.

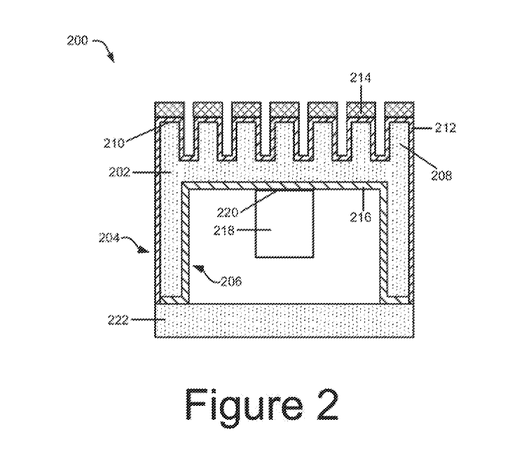

In an example, the charging device 100 may include a housing (not shown in figure), which in turn houses a planar supporting structure 102 of predefined thickness. The planar supporting structure 102 may be composed of metallic materials, such as aluminum, magnesium, zinc, titanium, niobium, copper, iron, silicon carbide, or any alloys thereof. In another example, as will be described later in FIG. 2, the planar supporting structure 102 may be fabricated using a material, such as plastic.

The planar supporting structure 102 includes two surfaces, namely a first surface 104 and a second surface 106. As would be explained in the later portions of the present description, the planar supporting structure 102 may support one or more components of the charging device 100. The first surface 104 of the planar supporting structure 102 comprises a plurality of projections 108, extending from the first surface 104. Although FIG. 1 illustrates the projections 108 extending orthogonally from the first surface 104, the projections 108 may be inclined at any angle to the first surface 104, without deviating from the scope of the present subject matter. Each of the projections 108 may extend from their respective bases (on the first surface 104), and may terminate at an end 110, also referred to as a tip end 110. The projections 108 may also be of different shapes. For example, the projections 108 may be semi-spherical, pyramidal, semi-oval, trapezoidal, or rectangular in shape. The projections 108 help to increase the effective surface of the first surface 104, and also thus increase heat dissipation.

In an example, the first surface 104 and the tip ends 110 have a thermal radiation coating 112. The thermal radiation coating 112 may be composed of a material that may enhance the rate of dissipation of heat through thermal radiation. In such cases, such materials may be considered as possessing high thermal radiance, i.e., materials which assist in rate of dissipation of thermal energy through radiation. For instance, the thermal radiation coating 112 may be of different types of material. For example, the thermal radiation coating 112 may based on any one of the allotropic forms of carbon, such as graphene, carbon nanotubes, diamond like carbon, and graphite. Furthermore, various combinations of such materials may also be used to prepare the thermal radiation coating 112 without deviating from the scope of the present subject matter.

Furthermore, the tip end 110 of each of the projections 108 may have a thermal insulation coating 114. In an example, the thermal insulation coating 114 is so applied, such that it overlaps the thermal radiation coating 112. The thermal insulation coating 114 may be based on a material which inhibits the conduction of heat, i.e., it is a thermal insulator. The thermal insulation coating 114 reduces the heat dissipated in the surrounding environment and the inner surface of the charging device 100 from the tip ends 110. Thus, the probability of a user of the charging device 100 experiencing discomfort or sustaining heat related injuries while placing or retrieving a communication device from the surface of the charging device 100 is reduced.

The thermal insulation coating 114 may compose of materials, such as fiberglass, mineral wool, cellulose, calcium silicate, cellular glass, and an elastomer. Furthermore, various combinations of such materials may also be used to prepare the thermal insulation coating 114 without deviating from the scope of the present subject matter.

In an example, the second surface 106 of the planar supporting structure 102 may have a thermal conductive coating 116 to affect transfer of heat generated by various components of the charging device 100, through conductance. The thermal conductive coating 116 may be of a material that may enhance the thermal conductance of the planar supporting structure 102. Additionally, the thermal conductive coating 116 may also enhance the thermal conductance of a component abutted, i.e., in physical contact with the thermal conductive coating 116. The thermal conductive 116 may be fabricated using one of an allotropic form of carbon and a powdered form of a ceramic material. In an example where the planar supporting structure 102 is composed of a metallic material, the thermal conductive coating 116 may be coated over a portion of the second surface.

The charging device 100 may further comprise a magnetic core 118 disposed over the second surface 106. The magnetic core 118 may be used in conjunction with a coil (not shown in figure) for producing an electromagnetic field for wirelessly charging communication devices. In an example, the magnetic core 118 may be fabricated using metallic material, for example, using copper. In an example, as illustrated in the figure, the magnetic core 118 may be abutted to the portion of the second surface having the thermal conductive coating 116 at a surface 120 of the magnetic core 118. The charging device 100 may further comprise a cover 122. The cover 122 may be comprise materials, such as plastic, and may provide support for the components of the charging device 100.

Further, in an example, a component or a plate (not shown in the figure) comprising a ferrite material may be disposed under the magnetic core 118 to reduce the effect of the eddy currents induced by the magnetic core 118.

During prolonged use of the charging device 100, the magnetic core 11 may heat up. In such a case, the thermal conductive coating 116 may facilitate conductance of the heat through the second surface 106 of the planar supporting structure 102. Owing to the thermal conductive coating 116, the heat may conduct from the magnetic core 118 to the planar supporting structure 102, at a faster rate. Due to conduction, the heat extracted from the magnetic core 118 is transmitted to the first surface 104 of the planar supporting structure 102. Form the first surface 104, the heat may dissipate into the air surrounding the planar supporting structure 102 through the projections 108. The thermal radiation coating 112 coated on the first surface 104 may facilitate the dissipation of heat at a faster rate. Further, the thermal insulation coating 114 coated on the tip ends 110 prevents heat dissipated from the tip ends 110 and thus, a surface of the charging device 100 in vicinity to the tip ends 110 may not heat up. Thus, instances of a user experiencing discomfort or sustaining heat related injuries are reduced.

FIG. 2 illustrates a block diagram of a charging device 200, according to an example of the present subject matter. The charging device 200 comprises a planar supporting structure 202, such as the planar supporting structure 102. Similar to the example discussed in conjunction with FIG. 1, the planar supporting structure 202 also includes a first surface 204 and a second surface 206. The first surface 204 of the planar supporting structure 202 further includes a plurality of projections 208, such as the projections 108. The projections 208 extend from the first surface 204 till a tip end 210. In an example, as illustrated in the figure, the planar supporting structure 202 may be fabricated using non-metallic materials, such as plastics. Usage of such materials for fabricating the charging device 200 may provide a light weight, high throughput and a cost effective approach for fabricating the charging device 200. In the present example, the entire second surface 206 of the planar supporting structure 202 may have a thermal conductive coating 216, such as the thermal conductive coating 116, coated. The thermal conductive coating 2 enhances the thermal conductivity of the plastic.

In the present example, each of the tip ends 210 of the projections 208 has a thermal insulation coating 214, similar to the thermal insulation coating 114. The thermal insulation coating 214 is provided on the tip ends 210 in a manner such that the thermal insulation coating 214 overlaps a thermal radiation coating 212, such as the thermal radiation coating 112, extending over the first surface 204. As also illustrated in FIG. 2, the charging device 200 may further include a magnetic core 218, such as the magnetic core 118. Although the present illustration depicts the magnetic core 218, the charging device 200 may also include additional components (not shown in the figure) without deviating from the scope of the present subject matter.

The magnetic core 218 is so placed, such that it is in physical contact with the second surface 206, with the thermal conductive coating 216 interspersed between. The planar supporting structure 202 provides support for the magnetic core 218, and for other components. Additionally, a cover 222 of the charging device 200 may also provide support to the other components of the charging device 200.

In operation, the heat generated by the magnetic core 218 (or other components) in contact with the second surface 206, is extracted by the thermal conductive coating 216. The thermal conductive coating 216 allows the portion of the thermal radiation coating 212 provided on the first surface 204, to be also heated by way of conduction. The surface area of the first surface 204 is exposed to the inner environment of the charging device 200. The heat conducted by the portion of the thermal radiation coating 212 on the first surface 204 is dissipated to the inner environment of the charging device 200. Furthermore, since the tip ends 210 of the projections 208 are provided with the thermal insulation coating 214, the heating of the tip ends 210 do not result in heating of the inner surface of the charging device 200.

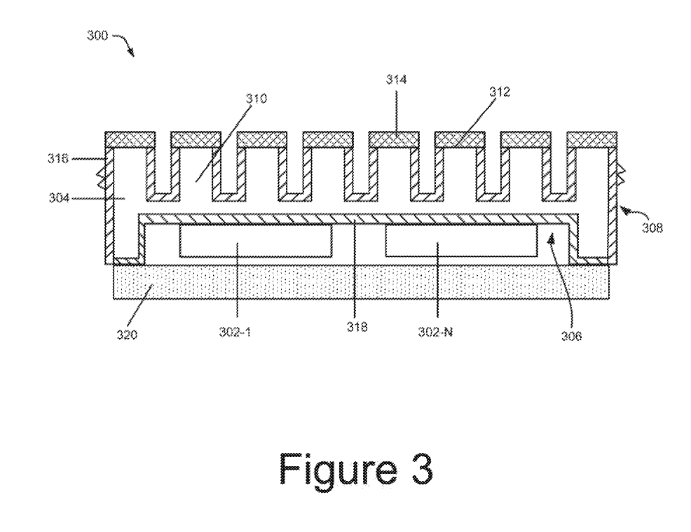

FIG. 3 illustrates a block diagram of a charging device 300 for charging electronic devices, according to an example of the present subject matter. The charging device 300, in an example, may comprise a plurality of components 302-1, . . . , 302-N, collectively referred to as the components 302, and individually referred to as component 302. Examples of components 302 may include, but are not limited to, transistors, resistors, charging coils, rectifiers, and other such components used in charging circuitry.

The charging device 300 further comprises a supporting plane 304 having a first surface 306 and a second surface 308. The components 302 are so positioned, such that they are in physical contact with the second surface 308. As will be described below, the second surface 308 may have a coating coated intermediary to the second surface 308 and the top surfaces of the components 304 for facilitating effective dissipation of heat from the components 304.

In an example, the first surface 306 comprises a plurality of protrusions 310 extending from the first surface 306 and terminating at a tip end 312. The protrusions 310 provide for increasing a surface area of the first surface 306 of the supporting plane 304 for affecting effective dissipation of heat through radiation. In the example, the tip ends 312 are provided with a thermal insulation coating 314, such as the thermal insulation coating 114 to reduce the heat dissipated from the tip ends 312. As should be noted, the components 302 and the supporting plane 304 may be enclosed in a housing of the charging device 300. In the present example, certain inner portions of the housing would be proximal to the tip ends 312. With the thermal insulation coating 314 applied to the tip ends 312, the heat being radiated by the tip ends 312 is reduced. As a result, heating of inner portions of the charging device 300 or other components in vicinity to the tip ends 312 may be minimized. Thus, probability of a user experiencing discomfort or sustaining minor heat related injuries due to overheating of the surface of the charging device 300 is reduced. In an example, the thermal insulation coating 314 may be prepared from materials, such as phenolic foam, vermiculite, polyurethane foam, and polystyrene foam. In an example, the polystyrene foam may be either partially or completely immersed in a polymeric resin. The remainder of the first surface 306 may be coated with a thermal radiation coating 316, such as the thermal radiation coating 112, which enhances radiation of heat from the first surface 306.

The second surface 308 of the supporting plane 304 may have a thermal conductive coating 318, such as the thermal conductive coating 116. The thermal conductive coating 318 affects conductance of heat from both, the components 302 and the supporting plane 304. As illustrated in the figure, the top surfaces of the components 302 intersperse the thermal conductive coating 318. The thermal conductive coating 318 may be fabricated using allotropic forms of carbon. In another example, the thermal conductive coating 318 may be composed of a powdered form of metal. Further, the charging device 300 may have a cover 320, similar to the cover 122, for providing support for components of the charging device 300.

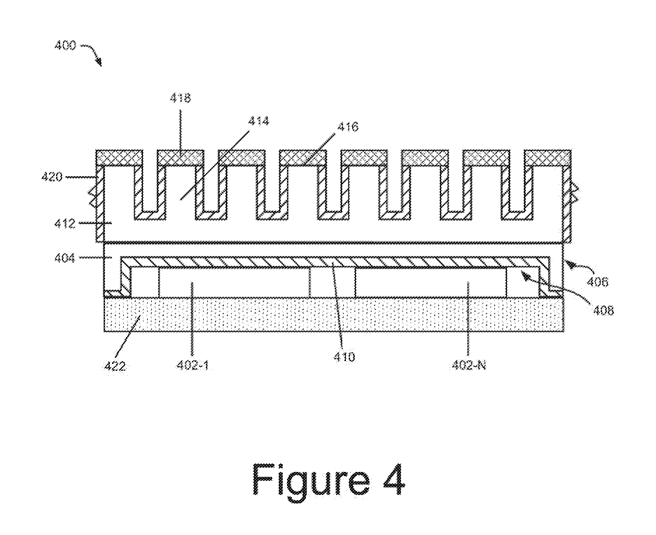

FIG. 4 illustrates a block diagram of a charging device 400, according to another example of the present subject matter. The charging device 400, in an example, includes a plurality of components 402-1, , . . . , 402-N, collectively referred to as the components 402, and individually referred to as component 402. For instance, the charging device 400 may include components, such as transistors resistors, induction coil, and power converters, integral to charging circuitry.

For facilitating effective dissipation of heat, the charging device 400, in an example, includes a planar supporting structure 404. The planar supporting structure 404 has a first surface 406 and a second surface 408 onto which the components 402 are disposed. In order to enhance the conductance of heat generated from the components 402, the second surface 408, has a thermal conductive coating 410, such as the thermal conductive coating 116. As can be seen in the figure, the components 402 are disposed over the second surface 408 such that a top surface of each of the components 402 intersperses the thermal conductive coating 410.

The charging device 400 further includes a heat sink 412 integrally coupled to the first surface 408 of the planar supporting structure 404. The heat sink 412 includes a surface having a plurality of projections 414. The projections 414, in effect, enhance a surface area of the heat sink 412 to facilitate dissipation of heat from the heat sink 412.

In the present example, each of the projections 414 has a tip end 416 coated with a thermal insulation coating 418, such as the thermal insulation coating 114. During operation, in a case where the components 402 may cause heating of the heat sink 412, the thermal insulation coating 418 reduces the heat dissipated from the tip ends 416. As a result, a surface of the charging device 400 in vicinity to the tip ends 416 may not overheat and probability of discomfort to a user of the charging device 400 is reduced. Further the remainder of the surface of the heat sink 412 is provided with a thermal radiation coating 420, such as the thermal radiation coating 112. The thermal radiation coating 420 affects the dissipation of heat into surrounding medium inside the charging device 400. Further, as shown in the figure, the charging device 400 may have a cover 422, similar to the cover 122, for providing support for components of the charging device 400. The cover 422, in an example, may be fabricated from materials, such as plastics.

Although examples for charging devices have been described in language specific to structural features and/or methods, it is to be understood that the appended claims are not limited to the specific features or methods described. Rather, the specific features and methods are disclosed as examples for charging devices.

1. A charging device comprising:
a planar supporting structure having a first surface and a second surface, wherein,
the first surface comprises a plurality of projections extending from the first surface, each of the plurality of projections having a tip end, wherein the first surface is coated with a thermal radiation coating such that the thermal radiation coating extends over an area of the first surface and the tip end, and wherein the tip end of each of the plurality of projections is further coated with a thermal insulation coating over the thermal radiation coating; and
a portion of the second surface is coated with a thermal conductive coating; and
a magnetic core disposed over the planar supporting structure, wherein the magnetic core abuts the thermal conductive coating interspersing the thermal conductive coating.

2. The charging device as claimed in claim 1, wherein the planar supporting structure comprises one of aluminum, iron, copper, and silicon carbide.

3. The charging device as claimed in claim 1, wherein the planar supporting structure comprises one of a plastic material, and wherein the thermal conductive coating is disposed over the entire area of second surface of the planar supporting structure.

4. The charging device as claimed in claim 1, wherein the thermal radiation coating comprises an allotropic form of carbon.

5. The charging device as claimed in claim 1, wherein the thermal insulation coating comprises one of fiberglass, mineral wool, cellulose, calcium silicate, cellular glass, and an elastomer.

6. The charging device as claimed in claim 1, wherein the thermal conductive coating comprises one of an allotropic form of carbon and a powdered form of a ceramic material.

7. The charging device as claimed in claim 1, wherein the magnetic core comprises a metallic material.

8. A charging device comprising:
a plurality of components, wherein the plurality of components is housed within the charging device; and
a supporting plane having a first surface and a second surface, wherein the plurality of components is positioned onto the second surface, wherein:
the first surface comprises a plurality of protrusions extending from the first surface, each of the protrusions having a tip end, wherein the tip end is coated with a thermal insulation coating, and remainder of area of the first surface is coated with a thermal radiation coating; and
a portion of the second surface s coated with a thermal conductive coating.

9. The charging device as claimed in claim 8, wherein the thermal radiation coating is provided over the tip end such that the thermal radiation coating intersperses between the tip end and the thermal insulation coating.

10. The charging device as claimed in claim 8, wherein the supporting plane comprises alloys of one of aluminum, zinc, magnesium, titanium, nobium, and silicon carbide.

11. The charging device as claimed in claim 8, wherein the thermal radiation coating comprises an allotropic form of carbon.

12. The charging device as claimed in claim 8, wherein the thermal insulation coating comprises one of phenolic foam, vermiculite, polyurethane foam, and polystyrene foam, wherein the polystyrene foam is partially immersed in a polymeric resin.

13. The charging device as claimed in claim 8, wherein the thermal conductive coating comprises one of an allotrope of carbon and a powdered form of a metal.

14. A charging device comprising:
a plurality of components, the components being housed within the charging device;
a planar structure having a first surface and a second surface, wherein the second surface is coated with a thermal conductive coating, and wherein the plurality of components are in physical contact with the second surface, interspersing the thermal conductive coating; and
a heat sink integrally coupled to the first surface of the planar structure, the heat sink having a plurality of projections extending from a surface of the heat sink, wherein each of the plurality of projections has a tip end, wherein the tip end is coated with a thermal insulation coating, and wherein remainder of area of the surface of the heat sink is coated with a thermal radiation coating.

15. The charging device as claimed in claim 14, wherein the thermal insulation coating comprises one of phenolic foam, vermiculite, polyurethane foam, and a polystyrene foam partially immersed in a polymeric material.
